(19) United States
(12) Patent Application Publication
(10) Pub. No.: US 2011/0107801 A1
(43) Pub. Date: May 12, 2011

(54) Theftproof Device for the Clutch of a Motorcycle

(76) Inventor: Yao-Ming Liu, Yongkang City (TW)

(21) Appl. No.: 12/614,555

(22) Filed: Nov. 9, 2009

(51) Int. Cl. E05B 65/12; F16M 5/00

(52) U.S. Cl. 70/236; 248/640

(57) ABSTRACT

A theftproof device for a motorcycle includes a housing, a slide movably mounted in the housing, a first clutch line having a first end secured on the slide and a second end protruding from the housing, a second clutch line having a first end secured on the slide and a second end protruding from the housing, and a locking member movably mounted in the housing and movable to abut the slide to stop movement of the slide, the first clutch line and the second clutch line. Thus, the locking member is moved upward to lock the slide so that the first clutch line and the second clutch line are locked and cannot be moved to prevent the clutch lever of the motorcycle from being operated so as to achieve a clutch theftproof function.

### BACKGROUND OF THE INVENTION

1. Field of the Invention

The present invention relates to a theftproof device and, more particularly, to a theftproof device for the accelerator of a normal motorcycle or the clutch of a heavy motorcycle.

2. Description of the Related Art

A conventional lock for a motorcycle is usually mounted on the front tire or rear tire of a motorcycle so as to achieve a theftproof function. However, the right and left clutch lines (of a heavy motorcycle) are not locked or the accelerator line and the clutch line (of a normal motorcycle) are not locked, so that when the lock is broken by a thief, the motorcycle can be moved freely after the lock is removed from the motorcycle, thereby failing the theftproof effect.

### BRIEF SUMMARY OF THE INVENTION

In accordance with the present invention, there is provided a theftproof device, comprising a housing, a slide movably mounted in the housing, a first clutch line extending through a first end of the housing and having a first end secured on a first end of the slide to move the slide and a second end protruding outwardly from the housing, a second clutch line extending through a second end of the housing 1 and having a first end secured on a second end of the slide to move the slide and a second end protruding outwardly from the housing, and a locking member movably mounted in the housing and movable to abut the slide to stop movement of the slide and to stop movement of the first clutch line and the second clutch line.

The primary objective of the present invention is to provide a theftproof device that provides a theftproof function to the clutch of a motorcycle.

According to the primary objective of the present invention, the locking member is moved upward to lock the slide so that the first clutch line and the second clutch line are locked and cannot be moved to prevent the clutch lever of the motorcycle from being operated even when the lock of the motorcycle is broken or stolen so as to achieve a first-stage theftproof function.

According to another objective of the present invention, when the locking member is moved upward to abut the slide, the locking rod of the locking member is inserted into and locked in the locking hole of the top cover to lock the top cover onto the housing and to prevent the top cover from being removed from the housing so as to achieve a second-stage theftproof function.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a theftproof device in accordance with the preferred embodiment of the present invention.

FIG. 2 is an exploded perspective view of the theftproof device as shown in FIG. 1.

FIG. 3 is a partially perspective assembly view of the theftproof device as shown in FIG. 2.

FIG. 4 is a partially perspective assembly view of the theftproof device as shown in FIG. 2.

FIG. 5 is a front view of the theftproof device as shown in FIG. 4.

FIG. 6 is a perspective view of the theftproof device for a motorcycle as shown in FIG. 1.

FIG. 7 is a schematic operational view of the theftproof device as shown in FIG. 4 in use.

FIG. 8 is a schematic operational view of the theftproof device as shown in FIG. 5 in use.

### DETAILED DESCRIPTION OF THE INVENTION

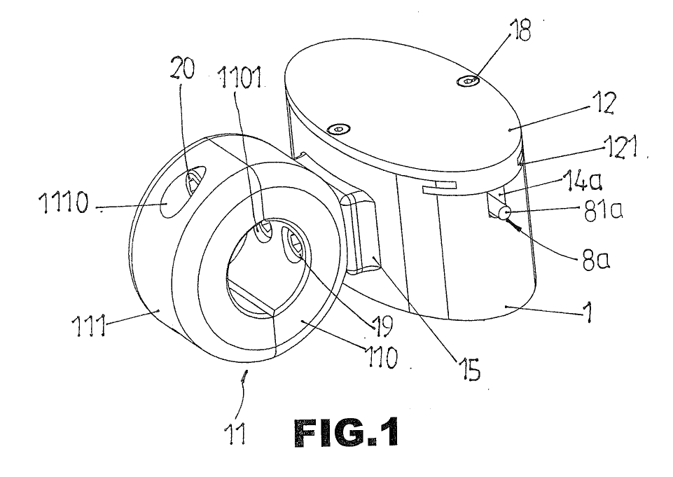

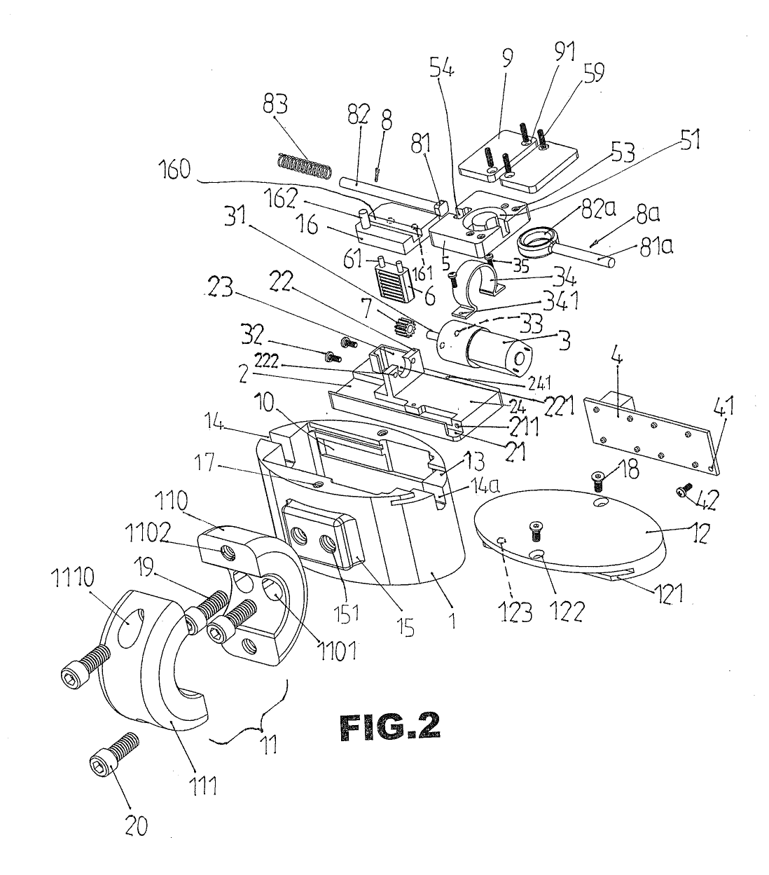

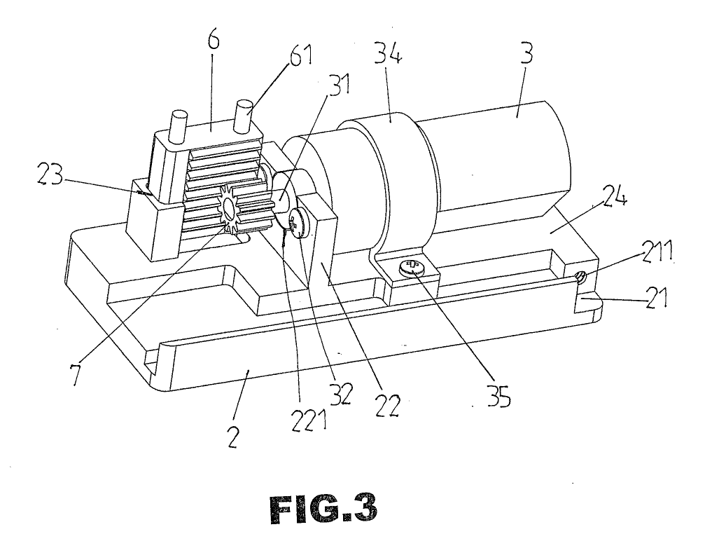

Referring to the drawings and initially to FIGS. 1-5, a theftproof device for the clutch of a motorcycle in accordance with the preferred embodiment of the present invention comprises a housing 1, a slide 5 movably mounted in the housing 1, a first clutch line 8 extending through a first end of the housing 1 and having a first end secured on a first end of the slide 5 to move the slide 5 and a second end 82 protruding outwardly from the housing 1, a second clutch line 8a extending through a second end of the housing 1 and having a first end secured on a second end of the slide 5 to move the slide 5 and a second end 81a protruding outwardly from the housing 1, a locking member 16 movably mounted in the housing 1 and movable to abut the slide 5 to stop movement of the slide 5 and to stop movement of the first clutch line 8 and the second clutch line 8a, a toothed rack 6 movably mounted in the housing 1 and connected with the locking member 16 to move the locking member 16 relative to the slide 5, a motor 3 mounted in the housing 1 and having a propeller shaft 31, a drive gear 7 mounted on and rotated by the propeller shaft 31 of the motor 3 and meshing with the toothed rack 6 to move the toothed rack 6 relative to the slide 5, a circuit board 4 mounted in the housing 1 and electrically connected with the motor 3 to control operation of the motor 3, a base 2 mounted in the housing 1 to support the motor 3 and the toothed rack 6, a fixing plate 34 secured on the base 2 and surrounding the motor 3 to fix the motor 3 on the base 2, a biasing member 83 mounted on the first clutch line 8 and biased between the first end of the housing 1 and the first end of the slide 5 to push the slide 5 toward the second end of the housing 1, two limit plates 9 secured on the slide 5 to move in concert with the slide 5 and movable to abut the second end of the housing 1 to stop movement of the slide 5, a top cover 12 removably mounted on an open top of the housing 1 to close the housing 1, and a connector 11 mounted on the housing 1.

The housing 1 has an outer wall provided with a mounting seat 15 for mounting the connector 11. The mounting seat 15 of the housing 1 has a side provided with two screw bores 151. The first end of the housing 1 is provided with a passage 14 to allow passage of the first clutch line 8, and the second end of the housing 1 is provided with a passage 14a to allow passage of the second clutch line 8a. The open top of the housing 1 has a side provided with two guide slots 13 for mounting the top cover 12. The open top of the housing 1 has a periphery provided with two screw holes 17 for fixing the top cover 12. The housing 1 has an inner wall provided with two guide tracks 10 to guide movement of the two limit plates 9.

The top cover 12 has a side provided with two protruding guide rails 121 inserted into the two guide slots 13 of the housing 1 respectively. The top cover 12 has a periphery provided with two through holes 122 aligning with the screw holes 17 of the housing 1, and the theftproof device further comprises two locking screws 18 extending through the two through holes 122 of the top cover 12 respectively and screwed into the screw holes 17 of the housing 1 respectively to lock the top cover 12 onto the housing 1. The top cover 12 has a bottom provided with a locking hole 123 facing the locking member 16.

The connector 11 has a ring shape and includes a first semi-circular clamp 110 secured on the mounting seat 15 of the housing 1 and a second semi-circular clamp 111 detachably combined with the first semi-circular clamp 110. The first semi-circular clamp 110 of the connector 11 has a mediate portion provided with two through bores 1101 aligning with the two screw bores 151 of the mounting seat 15, and the theftproof device further comprises two locking bolts 19 extending through the two through bores 1101 of the first semi-circular clamp 110 respectively and screwed into the two screw bores 151 of the mounting seat 15 respectively to lock the first semi-circular clamp 110 of the connector 11 onto the mounting seat 15 of the housing 1. The first semi-circular clamp 110 of the connector 11 has two end faces each provided with a screw bore 1102. The second semi-circular clamp 111 of the connector 11 has two end faces each provided with a stepped through bore 1110 aligning with the screw bore 1102 of the first semi-circular clamp 110, and the theftproof device further comprises two fastening bolts 20 each extending through the respective through bore 1110 of the second semi-circular clamp 111 and each screwed into the screw bore 1102 of the first semi-circular clamp 110 to combine the second semi-circular clamp 111 and the first semi-circular clamp 110 of the connector 11 together.

The slide 5 has a top provided with a plurality of screw holes 53. The first end of the slide 5 is provided with a fixing recess 54 to fix the first end of the first clutch line 8. The second end of the slide 5 is provided with a retaining groove 51 to fix the first end of the second clutch line 8a. The first end of the first clutch line 8 is provided with a fixing head 81 received in the fixing recess 54 of the slide 5 and stopped by one of the two limit plates 9. The first end of the second clutch line 8a is provided with a retaining head 82a received in the retaining groove 51 of the slide 5 and stopped by the other one of the two limit plates 9.

Each of the two limit plates 9 has a periphery provided with two through holes 91 aligning with the screw holes 53 of the slide 5, and the theftproof device further comprises two locking screws 59 extending through the through holes 91 of each of the two limit plates 9 respectively and screwed into the screw holes 53 of the slide 5 respectively to lock each of the two limit plates 9 onto the slide 5.

The locking member 16 is located under the first clutch line 8 and beneath the slide 5. The locking member 16 has a face provided with a receiving space 160 to receive the first clutch line 8 when the locking member 16 is movable to abut the slide 5. The locking member 16 has a top provided with a locking rod 162 that is inserted into and detachably locked in the locking hole 123 of the top cover 12 when the locking member 16 is movable to abut the slide 5 to lock the top cover 12 onto the housing 1. The locking member 16 has a bottom provided with two fixing holes 161.

The base 2 has a side provided with an elongate fixing slot 21 to fix the circuit board 4. The fixing slot 21 of the base 2 has an end provided with a screw hole 211. The base 2 has a first end provided with a platform 24 to support the motor 3 and the fixing plate 34 and a second end provided with a support seat 23 to support the toothed rack 6. The platform 24 of the base 2 has two opposite sides each provided with a screw bore 241. The base 2 has a mediate portion provided with an upright baffle 22 located between the platform 24 and the support seat 23 to separate the toothed rack 6 from the motor 3. The baffle 22 of the base 2 has a top provided with a semi-circular mounting recess 221 for mounting the propeller shaft 31 of the motor 3. The baffle 22 of the base 2 has a periphery provided with two through holes 222.

The toothed rack 6 is movably mounted in the support seat 23 of the base 2 and located under the locking member 16. The toothed rack 6 is has a top provided with two fixing posts 61 fixed in the two fixing holes 161 of the locking member 16 respectively to combine the toothed rack 6 and the locking member 16 together.

The motor 3 is located under the slide 5. The motor 3 has an end face provided with two screw holes 33 aligning with the through holes 222 of the baffle 22 respectively, and the theftproof device further comprises two locking screws 32 extending through the through holes 222 of the baffle 22 respectively and screwed into the screw holes 33 of the motor 3 respectively to lock the motor 3 onto the baffle 22.

The fixing plate 34 has a substantially C-shaped profile and has two opposite ends each provided with a through bore 341 aligning with the screw bore 241 of the platform 24, and the theftproof device further comprises two locking screws 35 each extending through the respective through bore 341 of the fixing plate 34 and each screwed into the respective screw bore 241 of the platform 24 to lock the fixing plate 34 onto the platform 24 of the base 2.

The circuit board 4 is inserted into the fixing slot 21 of the base 2 and has an end provided with a through hole 41 aligning with the screw hole 211 of the base 2, and the theftproof device further comprises a locking screw 42 extending through the through hole 41 of the circuit board 4 and screwed into the screw hole 211 of the base 2 to lock the circuit board 4 onto the base 2.

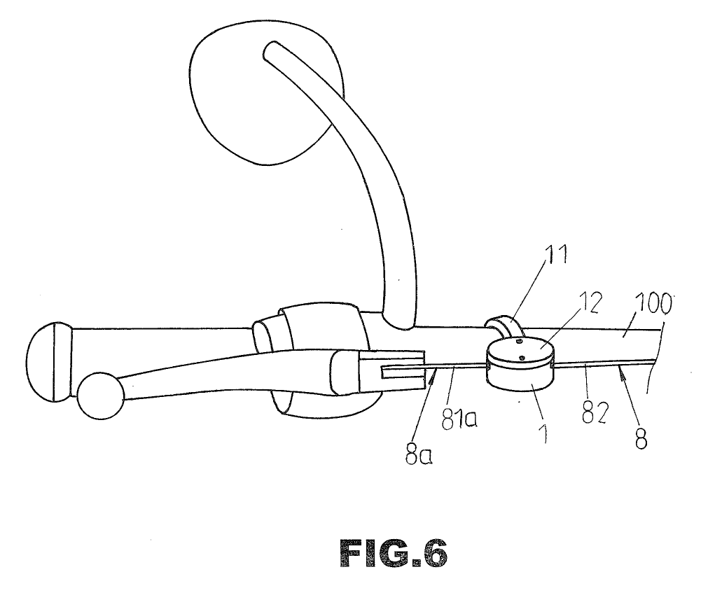

In operation, referring to FIGS. 6-8 with reference to FIGS. 1-5, when the theftproof device is applied to a motorcycle, the connector 11 is mounted on the handlebar 100 of the motorcycle. Then, the first clutch line 8 and the second clutch line 8a are connected to the gear shift and the clutch lever of the motorcycle respectively.

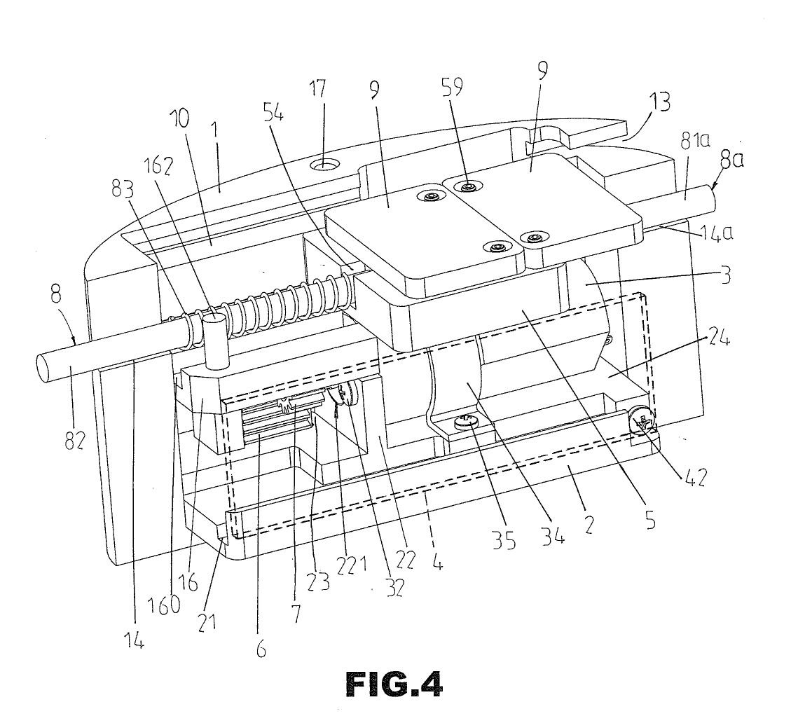

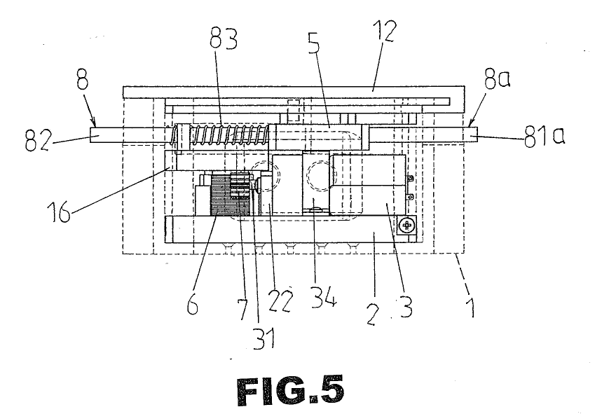

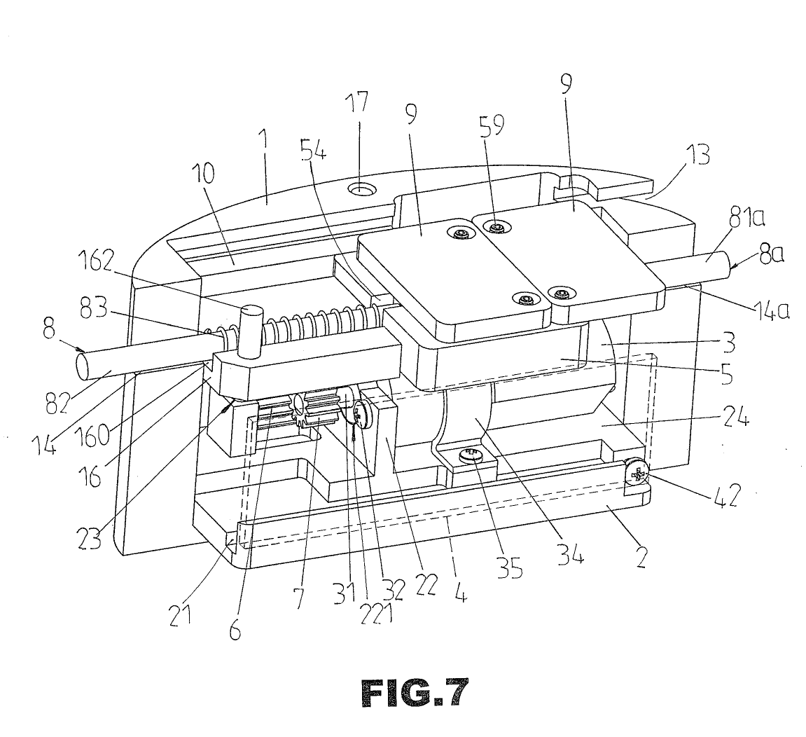

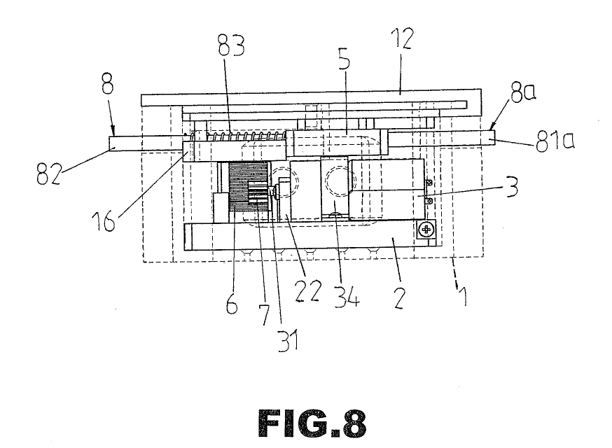

In such a manner, when the motor 3 is operated by the circuit board 4 which is controlled by a remote controller, the propeller shaft 31 of the motor 3 is rotated to rotate the drive gear 7 which drives and moves the toothed rack 6 which drives the locking member 16 to move upward relative to the slide 5, so that the locking member 16 is moved upward from the position as shown in FIGS. 4 and 5 to the position as shown in FIGS. 7 and 8 to abut the slide 5 so as to stop movement of the slide 5 and to stop movement of the first clutch line 8 and the second clutch line 8a. Thus, the slide 5 is locked by the locking member 16 so that the first clutch line 8 and the second clutch line 8a are locked and cannot be moved to prevent the gear shift and the clutch lever of the motorcycle from being operated so as to achieve a first-stage theftproof function. At the same time, when the locking member 16 is moved upward to abut the slide 5, the locking rod 162 of the locking member 16 is inserted into and locked in the locking hole 123 of the top cover 12 to lock the top cover 12 onto the housing 1 and to prevent the top cover 12 from being removed from the housing 1 so as to achieve a second-stage theftproof function.

On the contrary, when the motor 3 is operated by the circuit board 4 in the opposite direction, the propeller shaft 31 of the motor 3 is rotated to rotate the drive gear 7 which drives and moves the toothed rack 6 which drives the locking member 16 to move downward relative to the slide 5, so that the locking member 16 is moved downward from the position as shown in FIGS. 7 and 8 to the position as shown in FIGS. 4 and 5 to space from the slide 5 so as to allow movement of the slide 5 and to allow movement of the first clutch line 8 and the second clutch line 8a. Thus, the slide 5 is unlocked from the locking member 16 so that the first clutch line 8 and the second clutch line 8a are unlocked and can be moved freely to so that the gear shift and the clutch lever of the motorcycle can be operated freely. At the same time, when the locking member 16 is moved downward to space from the slide 5, the locking rod 162 of the locking member 16 is detached from the locking hole 123 of the top cover 12 to unlock the top cover 12 from the housing 1 so that the top cover 12 can be removed from the housing 1.

Accordingly, the locking member 16 is moved upward to lock the slide 5 so that the first clutch line 8 and the second clutch line 8a are locked and cannot be moved to prevent the clutch lever of the motorcycle from being operated even when the lock of the motorcycle is broken or stolen so as to achieve a first-stage theftproof function. In addition, when the locking member 16 is moved upward to abut the slide 5, the locking rod 162 of the locking member 16 is inserted into and locked in the locking hole 123 of the top cover 12 to lock the top cover 12 onto the housing 1 and to prevent the top cover 12 from being removed from the housing 1 so as to achieve a second-stage theftproof function. Further, the theftproof device can be mounted between the left and right clutch lines of a heavy motorcycle and can also be mounted between the accelerator line and the clutch line of a normal motorcycle to achieve a theftproof effect, thereby greatly enhancing the versatility of the theftproof device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A theftproof device, comprising:
a housing;
a slide movably mounted in the housing;
a first clutch line extending through a first end of the housing and having a first end secured on a first end of the slide to move the slide and a second end protruding outwardly from the housing;
a second clutch line extending through a second end of the housing 1 and having a first end secured on a second end of the slide to move the slide and a second end protruding outwardly from the housing;
a locking member movably mounted in the housing and movable to abut the slide to stop movement of the slide and to stop movement of the first clutch line and the second clutch line.

2. The theftproof device of claim 1, further comprising:
a toothed rack movably mounted in the housing and connected with the locking member to move the locking member relative to the slide;
a motor mounted in the housing and having a propeller shaft;
a drive gear mounted on and rotated by the propeller shaft of the motor and meshing with the toothed rack to move the toothed rack relative to the slide;
a circuit board mounted in the housing 1 and electrically connected with the motor to control operation of the motor.

3. The theftproof device of claim 1, further comprising:
a top cover removably mounted on an open top of the housing to close the housing.

4. The theftproof device of claim 3, wherein
the top cover has a bottom provided with a locking hole facing the locking member;
the locking member has a top provided with a locking rod that is inserted into and detachably locked in the locking hole of the top cover when the locking member is movable to abut the slide to lock the top cover onto the housing.

5. The theftproof device of claim 2, further comprising:
a base mounted in the housing to support the motor and the toothed rack.

6. The theftproof device of claim 2, further comprising:
a biasing member mounted on the first clutch line and biased between the first end of the housing and the first end of the slide to push the slide toward the second end of the housing.

7. The theftproof device of claim 6, further comprising:
two limit plates secured on the slide to move in concert with the slide and movable to abut the second end of the housing to stop movement of the slide.

8. The theftproof device of claim 1, further comprising:
a connector mounted on the housing.

9. The theftproof device of claim 6, wherein
the locking member is located under the first clutch line and beneath the slide;
the locking member has a face provided with a receiving space to receive the first clutch line when the locking member is movable to abut the slide;
the locking member has a bottom provided with two fixing holes;
the toothed rack is has a top provided with two fixing posts fixed in the two fixing holes of the locking member respectively to combine the toothed rack and the locking member together.

10. The theftproof device of claim 5, wherein
the base has a first end provided with a platform to support the motor and a second end provided with a support seat to support the toothed rack;
the base has a mediate portion provided with an upright baffle located between the platform and the support seat to separate the toothed rack from the motor;
the toothed rack is movably mounted in the support seat of the base and located under the locking member.

11. The theftproof device of claim 10, wherein
the baffle of the base has a top provided with a semi-circular mounting recess for mounting the propeller shaft of the motor;
the baffle of the base has a periphery provided with two through holes;
the motor is located under the slide;
the motor has an end face provided with two screw holes aligning with the through holes of the baffle respectively;
the theftproof device further comprises two locking screws extending through the through holes of the baffle respectively and screwed into the screw holes of the motor respectively to lock the motor onto the baffle.

12. The theftproof device of claim 5, further comprising:
a fixing plate secured on the base and surrounding the motor to fix the motor on the base.

13. The theftproof device of claim 12, wherein
the platform of the base has two opposite sides each provided with a screw bore;
the fixing plate has a substantially C-shaped profile and has two opposite ends each provided with a through bore aligning with the screw bore of the platform;
the theftproof device further comprises two locking screws each extending through the respective through bore of the fixing plate and each screwed into the respective screw bore of the platform to lock the fixing plate onto the platform of the base.

14. The theftproof device of claim 5, wherein
the base has a side provided with an elongate fixing slot to fix the circuit board;
the fixing slot of the base has an end provided with a screw hole;
the circuit board is inserted into the fixing slot of the base and has an end provided with a through hole aligning with the screw hole of the base;
the theftproof device further comprises a locking screw extending through the through hole of the circuit board and screwed into the screw hole of the base to lock the circuit board onto the base.

15. The theftproof device of claim 7, wherein
the first end of the slide is provided with a fixing recess to fix the first end of the first clutch line;
the second end of the slide is provided with a retaining groove to fix the first end of the second clutch line;
the first end of the first clutch line is provided with a fixing head received in the fixing recess of the slide and stopped by one of the two limit plates;
the first end of the second clutch line is provided with a retaining head received in the retaining groove of the slide and stopped by the other one of the two limit plates;
the first end of the housing is provided with a passage to allow passage of the first clutch line;
the second end of the housing is provided with a passage to allow passage of the second clutch line.

16. The theftproof device of claim 8, wherein
the housing has an outer wall provided with a mounting seat for mounting the connector;
the mounting seat of the housing has a side provided with two screw bores;
the connector has a ring shape and includes a first semi-circular clamp secured on the mounting seat of the housing and a second semi-circular clamp detachably combined with the first semi-circular clamp;
the first semi-circular clamp of the connector has a mediate portion provided with two through bores aligning with the two screw bores of the mounting seat;
the theftproof device further comprises two locking bolts extending through the two through bores of the first semi-circular clamp respectively and screwed into the two screw bores of the mounting seat respectively to lock the first semi-circular clamp of the connector onto the mounting seat of the housing;
the first semi-circular clamp of the connector has two end faces each provided with a screw bore;
the second semi-circular clamp of the connector has two end faces each provided with a stepped through bore aligning with the screw bore of the first semi-circular clamp;
the theftproof device further comprises two fastening bolts each extending through the respective through bore of the second semi-circular clamp and each screwed into the screw bore of the first semi-circular clamp to combine the second semi-circular clamp and the first semi-circular clamp of the connector together.

17. The theftproof device of claim 3, wherein
the open top of the housing has a periphery provided with two screw holes for fixing the top cover;
the top cover has a periphery provided with two through holes aligning with the screw holes of the housing;
the theftproof device further comprises two locking screws extending through the two through holes of the top cover respectively and screwed into the screw holes of the housing respectively to lock the top cover onto the housing.

18. The theftproof device of claim 7, wherein
the slide has a top provided with a plurality of screw holes;
each of the two limit plates has a periphery provided with two through holes aligning with the screw holes of the slide;
the theftproof device further comprises two locking screws extending through the through holes of each of the two limit plates respectively and screwed into the screw holes of the slide respectively to lock each of the two limit plates onto the slide.

19. The theftproof device of claim 3, wherein
the open top of the housing has a side provided with two guide slots for mounting the top cover;
the top cover has a side provided with two protruding guide rails inserted into the two guide slots of the housing respectively.

20. The theftproof device of claim 7, wherein the housing has an inner wall provided with two guide tracks to guide movement of the two limit plates.
